(19) United States
(12) Patent Application Publication
(10) Pub. No.: US 2010/0163578 A1
(43) Pub. Date: Jul. 1, 2010

(54) DISPENSER CAP RETAINER FOR CHILD RESISTANT CONCENTRATE CARTRIDGE

(76) Inventors: Edward L. Mueller, Toledo, OH (US); R. Bruce Yacko, Toledo, OH (US)

Correspondence Address: FRASER CLEMENS MARTIN & MILLER LLC, 28366 KENSINGTON LANE, PERRYSBURG, OH, 43551, US

(21) Appl. No.: 12/648,623

(22) Filed: Dec. 29, 2009

Related U.S. Application Data
(60) Provisional application No. 61/141,365, filed on Dec. 30, 2008.

(51) Int. Cl. B67D 7/74; B67D 7/70; B67D 7/58

(52) U.S. Cl. 222/129; 222/383.1; 222/136

(57) ABSTRACT

A reusable, child resistant concentrate cartridge adapted to be supporting between a diluents container for combining at least two separate components of a multi-component system and an associated dispenser is disclosed. The concentrate cartridge is provided with a hollow cylindrical body and a hollow tube with a closure portion. The concentrate cartridge is caused to open by the rotating engagement of a closure cap having a depending hollow cylinder formed thereon on a dispensing sprayer which causes the closure portion of the hollow tube to disengage and release concentrate material into the diluents container.

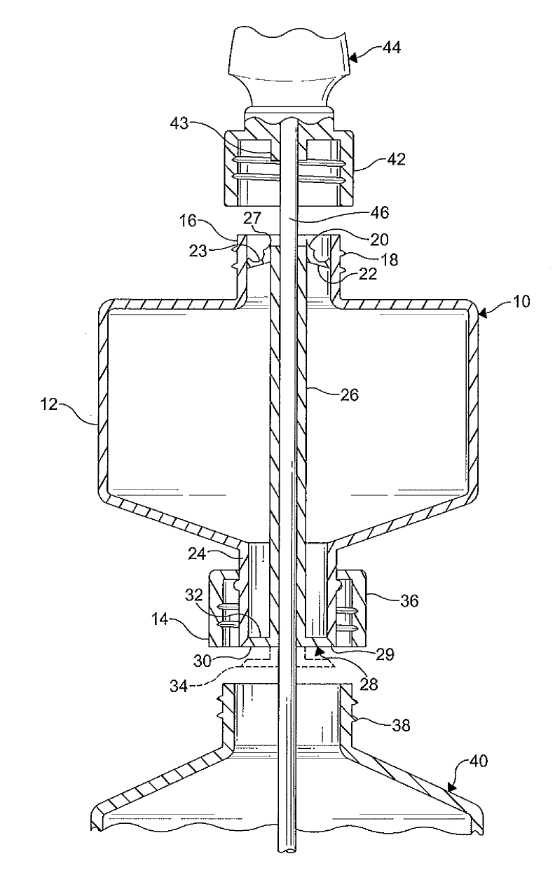

### CROSS-REFERENCE TO RELATED APPLICATION

This application claims the benefit of priority of U.S. Provisional Patent Application Ser. No. 61/141,365 filed on Dec. 30, 2008 hereby incorporated herein by reference.

### FIELD OF THE INVENTION

The invention relates to a dispenser cap retainer for a child resistant concentrate cartridge for a diluting and dispensing container.

### BACKGROUND OF THE INVENTION

Representative of the most current reusable concentrate cartridge is illustrated and described in U.S. Pat. No. 6,290,100 entitled “Concentrate Cartridge for a Diluting and Dispensing Container” issued in the names of R. Bruce Yacko and Edward L. Mueller.

The combination of the concentrate cartridge and the dispensing container includes a hollow bottle for containing a liquid diluent having a neck portion for supporting a concentrate cartridge for containing a concentrate, wherein the cartridge comprises a hollow cylindrical element having a first open end forming a closure seat and a second end including a flange extending outwardly of the cylindrical element, an annular collar, and an annular web having a U-shaped cross-section interconnecting the collar and the flange of the first cylindrical element, and a second end terminating in a radially outwardly extending closure adapted to selectively seat with the closure seat of the hollow cylindrical element to form a fluid-tight closure therebetween; a closure cap including a dispensing means and means to mate with the neck portion of the hollow bottle to provide a tight seal; and a dip tube communicating with the dispensing means inserted through the hollow cylindrical element of the cartridge, and into the hollow bottle.

It would be desirable to produce a concentrate cartridge wherein the closure is resistant to being opened by an individual such as a child and may be readily opened by a specially designed dispenser cap.

### SUMMARY OF THE INVENTION

Harmonious with the present invention, a concentrate cartridge which would be readily adaptable to be received and utilized with a broad range of diluent containers and dispensers, has surprisingly been discovered.

The above objectives, as well as others, may typically be achieved by a concentrate cartridge comprising: a hollow main body having a first open end forming a closure seat and a spaced apart second end; a hollow tube having a first end portion in substantially fluid-tight sliding relation with the main body, and a second end portion including a closure adapted to selectively seat with the closure seat of the main body to form a substantially fluid-tight closure therebetween; a means for coupling the first open end of the main body to a diluting and dispensing container; and a retainer cap for coupling the second end of the main body to a dispenser sprayer, the cap including a depending hollow cylinder capable of contacting the first end portion of the hollow tube to effect a movement of the closure away from the closure seat.

### BRIEF DESCRIPTION OF THE DRAWINGS

The above object, as well as other objects and advantages of the invention will become readily apparent to one skilled in the art from reading the following detailed description of the invention when considered in the light of the accompanying drawings, in which the figure is an exploded elevational view partially in section of a child resistant concentrate cartridge in combination with a spray dispenser and a diluted container incorporating the features of the present invention.

### DETAILED DESCRIPTION OF THE PREFERRED EMBODIMENTS OF THE INVENTION

The following detailed description and appended drawing describe and illustrate various exemplary embodiments of the invention. The description and drawing serve to enable one skilled in the art to make and use the invention, and are not intended to limit the scope of the invention in any manner.

Referring to the figure, there is shown a concentrate cartridge 10 having a hollow cylindrical main body 12. In the embodiment shown, the concentrate cartridge 10 is formed from a plastic material. It is understood that any suitable material can be used to produce the concentrate cartridge 10, the bottom or lower end 14 of the main body 12 is open. The opposite or upper end is provided with an upwardly extending neck finish 16 provided with external threads 18.

The upper end of the neck finish 16 includes an annular collar 20 which is interconnected to an inner portion of the neck finish 16 by an annular web 22. It will be observed that the inner surface of the neck finish 16, the annular web 22, and the outer surface of the annular collar 20 form a trough 23 which is generally U-shaped in cross-section.

The lower end 14 of the main body 12 is provided with a downwardly depending cylindrical portion.

The concentrate cartridge 10 includes an associated closure member comprised of a hollow tube 26 having an open first end portion 27 and a radially outwardly extending closure 28 at a second end portion thereof. An outer surface of the first end portion 27 slidably engages the annular collar 20 of the neck finish 16 and creates a substantially fluid tight seal therebetween. The closure 28 is formed with a generally flat outer surface 30 and an opposing inner surface 32. An outer peripheral surface of the inner surface 32 is provided with a sealing surface 34 which is caused to normally sealingly engage an annular surface such as a closure seat 29 at the outlet end of the dispensing portion 24.

The downwardly extending cylindrical portion 24 of the concentrate cartridge 10 is provided with a closure cap 36 which may be rotatingly coupled to a neck finish of an associated diluting and dispensing container 40.

The concentrate cartridge 10 is typically filled with the desired concentrate and attached to an associated diluting and dispensing container 40. A closure cap 36 is adapted to be tightened on the neck finish 38 of the diluting and dispensing container 40. A fluid-tight coupling between the concentrate cartridge 10 and the diluting and dispensing container 40 is thereby established.

It will be appreciated that since the uppermost end 27 of the hollow tube 26 is below the annular collar 20, the tube 26 cannot be readily depressed by the finger of a child, for example. Therefore, the illustrated embodiment of the concentrate cartridge 10 is referred to as a child resistant cartridge.

In order to move the closure 32 to an open position to allow the concentrate within the cartridge to be discharged into the associated container 40 the closure cap 42 of an associated dispensing sprayer is provided with a downwardly depending annular member 43. As shown in the figure, the annular member 43 is a cylinder.

The closure cap 42 of the associated dispensing sprayer 44 is adapted to be suitably tightened on the threads 18 formed on the neck finish 16 of the concentrate cartridge 10. The procedure is initiated by inserting a depending dip tube 46 of the dispensing sprayer 44 into the hollow tube 26. When the dip tube is fully inserted, the closure cap 42 of the dispensing sprayer 44 is tightened, causing member 43 of the closure cap 42 to engage the first end portion of the hollow tube 26, thus forcing the tube 26 to slide downwardly and simultaneously move the closure 28 to an open position by disengaging the sealing surface 34 from the seated position against the lower end 14 of the main body 12 of the concentrate cartridge 10. The open position is illustrated in the figure with dashed lines, and the closed position is illustrated in the figure with solid lines. The concentrate within the concentrate cartridge 10 is released into the diluting and dispensing container 40 and combined with any diluent contained in the diluting and dispensing container 40.

It will be noted that the present invention permits the main body 12 of the concentrate cartridge to be produced in a wide number of shapes and of differing capacities and, nevertheless, be utilized in the same dispensing sprayer 44 and diluting and dispensing container 40. This feature is particularly advantageous to a retailer who may wish to handle the sale of concentrate containers obtained from a number of different sources. Further, the concentrate cartridge 10 may be refilled with concentrate and reused.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A concentrate cartridge comprising:
a hollow main body having a first open end forming a closure seat and a spaced apart second end;
a hollow tube having a first end portion in substantially fluid-tight sliding relation with the main body, and a second end portion including a closure adapted to selectively seat with a closure seat of the main body to form a substantially fluid-tight closure therebetween;
a means for coupling the first open end of the main body to a diluting and dispensing container; and
a retainer cap for coupling the second end of the main body to a dispenser sprayer, the cap including a depending hollow cylinder capable of contacting the first end portion of the hollow tube to affect a movement of the closure away from the closure seat.

2. The concentrate cartridge of claim 1, wherein the second end of the main body includes a neck finish having threads formed therein.

3. The concentrate cartridge of claim 2, wherein the second end of the main body includes an annular collar formed thereon.

4. The concentrate cartridge of claim 3, wherein an annular web interconnects the annular collar and the neck finish.

5. The concentrate cartridge of claim 3, wherein the first end portion of the hollow tube is disposed below the annular collar.

6. The concentrate cartridge of claim 1, further comprising a threaded cap attached to the first open end of the main body for coupling the main body to a neck finish of the diluting and dispensing container.

7. The concentrate cartridge of claim 1, wherein the concentrate cartridge is formed from plastic.

8. The concentrate cartridge of claim 1, wherein the closure of the second end of the hollow tube has a sealing surface formed thereon.

9. The concentrate cartridge of claim 1, wherein the main body is disposed between the diluting and dispensing container and the dispensing sprayer.

10. A concentrate cartridge comprising:
a hollow main body having a first open end forming a closure seat and a spaced apart second end, wherein the second end of the main body includes an annular collar formed thereon;
a hollow tube having a first end portion in substantially fluid-tight sliding relation with the main body, and a second end portion including a closure adapted to selectively seat with a closure seat of the main body to form a substantially fluid-tight closure therebetween, wherein the first end portion is disposed below the annular collar;
a means for coupling the first open end of the main body to a diluting and dispensing container; and
a retainer cap for coupling the second end of the main body to a dispenser sprayer, the cap including a depending hollow cylinder capable of contacting the first end portion of the hollow tube to affect a movement of the closure away from the closure seat.

11. The concentrate cartridge of claim 10, wherein the second end of the main body includes a neck finish having threads formed therein.

12. The concentrate cartridge of claim 10, wherein an annular web interconnects the annular collar and the neck finish.

13. The concentrate cartridge of claim 10, further comprising a threaded cap attached to the first open end of the main body for coupling the main body to a neck finish of the diluting and dispensing container.

14. The concentrate cartridge of claim 10, wherein the concentrate cartridge is formed from plastic.

15. The concentrate cartridge of claim 10, wherein the closure of the second end of the hollow tube has a sealing surface formed thereon.

16. The concentrate cartridge of claim 10, wherein the main body is disposed between the diluting and dispensing container and the dispensing sprayer.

17. A concentrate cartridge comprising:
a hollow main body having a first open end forming a closure seat and a spaced apart second end including a neck finish, an annular collar, and an annular web having a generally U-shaped cross-section interconnecting the annular collar and the neck finish;
a hollow tube having a first end portion in substantially fluid-tight sliding relation with the main body, and a second end portion including a closure adapted to selectively seat with a closure seat of the main body to form a substantially fluid-tight closure therebetween;
a means for coupling the first open end of the main body to a diluting and dispensing container; and
a means for coupling the second end of the main body to a dispensing sprayer, the means for coupling including a depending hollow cylinder capable of contacting the first end portion of the hollow tube to affect a movement of the closure away from the closure seat.

18. The concentrate cartridge of claim 17, wherein the main body is disposed between the diluting and dispensing container and the dispensing sprayer.

19. The concentrate cartridge of claim 17, wherein the first end portion of the hollow tube is disposed below the annular collar.

20. The concentrate cartridge of claim 17, wherein the closure of the second end of the hollow tube has a sealing surface formed thereon.
